(19) United States
(12) Patent Application Publication
(10) Pub. No.: US 2017/0307924 A1
(43) Pub. Date: Oct. 26, 2017

(54) TOUCH CONTROL ELECTRODE STRUCTURE, TOUCH SCREEN AND DISPLAY APPARATUS

(71) Applicants: BOE TECHNOLOGY GROUP CO., LTD., Beijing (CN); CHENGDU BOE OPTOELECTRONICS TECHNOLOGY CO., LTD., Chengdu, Sichuan (CN)

(72) Inventors: Tingliang LIU, Beijing (CN); Shan GAO, Beijing (CN); Weiyun HUANG, Beijing (CN)

(21) Appl. No.: 15/520,596

(22) PCT Filed: Feb. 3, 2016
(86) PCT No.: PCT/CN2016/073282

§ 371 Date: Apr. 20, 2017

(30) Foreign Application Priority Data
Sep. 15, 2015 (CN) 201510587830.3

(51) Int. Cl. G02F 1/1333; G02F 1/1343; G06F 3/041; G06F 3/044

(52) U.S. Cl. CPC G02F 1/13338; G06F 3/044; G02F 1/1343; G06F 3/0412; G06F 2203/04103

(57) ABSTRACT

A touch electrode structure, a touch panel and a display device are provided. The touch electrode structure includes at least one touch electrode group. The at least one touch electrode group is arranged around a center; each touch electrode group includes a plurality of touch electrodes, the plurality of touch electrodes in each touch electrode group are arranged in the direction from the position closer to the center to the position further away from the center respectively; and a size of a side portion of each touch electrode away from the center along a circumferential direction is greater than a size of a side portion of the touch electrode close to the center along a circumferential direction. The touch electrode structure may be applied in a non-rectangular (irregular) touch panel, according to the requirements, the touch electrode structure can effectively and completely cover the non-rectangular (irregular) touch panel.

### TECHNICAL FIELD

At least one embodiment of the present disclosure relates to a touch electrode structure, a touch panel and a display device.

### BACKGROUND

As a new human-computer interaction device, touch panels greatly improve the efficiency and the convenience of man-machine interaction due to the characteristics of directness, high efficiency, accuracy, smoothness and fashion, and thus entertainment and official business become more lively and relaxed. Touch panels may be divided into a resistive type, a capacitive type and an infrared optical type, etc. The capacitive touch is mostly widely used in many touch technologies, and particularly a self-capacitive touch is widely used due to the light and thin properties of a touch panel formed by the self-capacitive touch.

A self-capacitive touch panel comprises a touch electrode array made of transparent conductive materials (for example, indium tin oxide (ITO)) and disposed on a base substrate, and capacitors are formed by the touch electrodes and the ground respectively. In the case that the self-capacitive touch panel is touched by a finger, the capacitance of the finger will be overlapped to the corresponding touch electrode, and a touch detection chip determines a touch position by detecting the capacitance variation of the touch electrodes in a touch period.

On the other hand, with the development of intelligent technology, intelligent wearable devices such as watches, Google glasses and wristbands are more and more favored by consumers. In addition to the features of thin, light, stylish and intelligent, almost all of the devices need a property of touch, and a good touch experience wins the market.

### SUMMARY

At least one embodiment of the present disclosure provides a touch electrode structure, a touch panel and a display device. The touch electrode structure may be applied in a non-rectangular (irregular) touch panel, according to the requirements, the touch electrode structure can effectively and completely cover the non-rectangular (irregular) touch panel, and the defects of inaccurate reporting, poor linearity and the like caused by the incomplete coverage of touch electrodes at edges or corners of the touch panel are avoided.

At least one embodiment of the present disclosure provides a touch electrode structure, and the touch electrode structure comprises at least one touch electrode group, the at least one touch electrode group is arranged around a center; each touch electrode group comprises a plurality of touch electrodes, the plurality of touch electrodes in each touch electrode group are arranged in a direction from a position closer to the center to a position further away from the center respectively; and a size of a side portion of each touch electrode away from the center along a circumferential direction is greater than a size of a side portion of the touch electrode close to the center along the circumferential direction.

For example, in the touch electrode structure provided in one embodiment of the present disclosure, the plurality of touch electrodes in each touch electrode group are arranged along a ray in the direction from the position closer to the center to the position further away from the center respectively; and the plurality of touch electrodes in each touch electrode group are arranged by taking the ray as a center line.

For example, in the touch electrode structure provided in one embodiment of the present disclosure, in the plurality of touch electrodes of each touch electrode group, an average size of the touch electrodes further away from the center along the circumferential direction is greater than an average size of the touch electrodes closer to the center along the circumferential direction.

For example, in the touch electrode structure provided in one embodiment of the present disclosure, a shape of the plurality of touch electrodes as a whole comprises an annular sector or a trapezoid.

For example, in the touch electrode structure provided in one embodiment of the present disclosure, a number of the touch electrode groups is plural; and circumferentially adjacent touch electrodes in the plurality of touch electrode groups are disposed in an annular sector region, a ring region, a polygonal region or a polygonal ring region.

For example, in the touch electrode structure provided in one embodiment of the present disclosure, each touch electrode group is disposed in an annular sector region or a trapezoidal region; and the plurality of touch electrodes in each touch electrode group almost cover the annular sector region or the trapezoidal region.

For example, in the touch electrode structure provided in one embodiment of the present disclosure, each touch electrode group is disposed in an annular sector region, and circumferentially adjacent touch electrodes are disposed in an annular sector region or a ring region; or each touch electrode group is disposed in a trapezoidal region, and the circumferentially adjacent touch electrodes are disposed in a polygonal region or a polygonal ring region.

For example, in the touch electrode structure provided in one embodiment of the present disclosure, radial sizes of the touch electrodes arranged in the direction from the position closer to the center to the position further away from the center are sequentially reduced.

For example, in the touch electrode structure provided in one embodiment of the present disclosure, an area of each touch electrode is equal or roughly equal.

For example, in the touch electrode structure provided in one embodiment of the present disclosure, at least one touch electrode in each touch electrode group comprises a plurality of circumferentially arranged sub-touch electrodes.

For example, in the touch electrode structure provided in one embodiment of the present disclosure, an area of each sub-touch electrode and an area of each touch electrode are equal or roughly equal.

For example, in the touch electrode structure provided in one embodiment of the present disclosure, a shape of the plurality of sub-touch electrodes as a whole comprises a polygon.

For example, the touch electrode structure provided in one embodiment of the present disclosure further comprises a center touch electrode, and the center touch electrode is disposed at the center.

For example, the touch electrode structure provided in one embodiment of the present disclosure is disposed in a non-rectangular region.

For example, in the touch electrode structure provided in one embodiment of the present disclosure, the non-rectangular region comprises a sector region, an annular sector region, a circular region, a ring region, a polygonal region and a polygonal ring region.

At least one embodiment of the present disclosure provides a touch panel, and the touch panel comprises any one of the above-mentioned touch electrode structure.

At least one embodiment of the present disclosure provides a display device, and the display device comprises any one of the above-mentioned touch electrode structure.

For example, the display device provided in one embodiment of the present disclosure further comprises a display panel, and the touch electrode structure is disposed on the display panel.

For example, in the display device provided in one embodiment of the present disclosure, the display device comprises a liquid crystal display device or an organic light-emitting diode display device.

### BRIEF DESCRIPTION OF THE DRAWINGS

In order to clearly illustrate the technical solutions of the embodiments of the present disclosure, the drawings of the embodiments will be briefly described in the following. It is obvious that the described drawings are only related to some embodiments of the present disclosure and thus are not limitative of the disclosure.

FIG. 1 is a schematic diagram in which rectangular touch electrodes cannot completely cover or exceed a non-rectangular display panel or a non-rectangular touch panel;

FIG. 2 is a schematic diagram of a touch electrode structure provided by one embodiment of the present disclosure;

FIG. 3a is a schematic diagram of the touch electrode structure provided by one embodiment of the present disclosure in which each touch electrode group is disposed in a sector region;

FIG. 3b is a schematic diagram of the touch electrode structure provided by one embodiment of the present disclosure in which each touch electrode group is disposed in a trapezoidal region;

FIG. 4a is a schematic diagram of the touch electrode structure provided by one embodiment of the present disclosure in which a plurality of circumferentially adjacent touch electrodes are disposed in a ring region;

FIG. 4b is a schematic diagram of the touch electrode structure provided by one embodiment of the present disclosure in which a plurality of circumferentially adjacent touch electrodes are disposed in a polygonal ring region;

FIG. 4c is a schematic diagram of the touch electrode structure provided by one embodiment of the present disclosure in which a plurality of circumferentially adjacent touch electrodes are disposed in an annular sector region;

FIG. 4d is a schematic diagram of the touch electrode structure provided by one embodiment of the present disclosure in which a plurality of circumferentially adjacent touch electrodes are disposed in a polygonal region;

FIG. 5a is a schematic diagram of the touch electrode structure further comprising a center touch electrode provided by one embodiment of the present disclosure (all the touch electrodes almost cover a circular region);

FIG. 5b is a schematic diagram of the touch electrode structure further comprising a center touch electrode provided by one embodiment of the present disclosure (all the touch electrodes almost cover a sector region);

FIG. 6a is a schematic diagram of via holes corresponding to a center touch electrode and a plurality of touch electrodes in each touch electrode group in the touch electrode structure provided by one embodiment of the present disclosure;

FIG. 6b is a schematic diagram of a center touch electrode, a plurality of touch electrodes in each touch electrode group, sub-touch electrodes, and via holes corresponding to the sub-touch electrodes in the touch electrode structure provided by one embodiment of the present disclosure;

FIG. 6c is a schematic diagram in which one part of a base substrate of a touch panel is covered by the touch electrode structure provided by one embodiment of the present disclosure;

FIG. 6d is a schematic diagram in which one part of a base substrate of a touch panel is covered by the touch electrode structure provided by one embodiment of the present disclosure, and the plurality of touch electrodes in the touch electrode group are divided into a plurality of sub-touch electrodes;

FIG. 6e is a schematic diagram of a touch panel provided by one embodiment of the present disclosure;

FIG. 7a is a schematic diagram of a touch panel or a display device provided by one embodiment of the present disclosure;

FIG. 7b is another schematic diagram of a touch panel or a display device provided by one embodiment of the present disclosure; and

FIG. 7c is another schematic diagram of a touch panel or a display device provided by one embodiment of the present disclosure.

### REFERENCE NUMERALS

10—touch electrode group; 20—center; 101—touch electrode; 011—side portion of touch electrode close to the center; 012—side portion of touch electrode away from the center; 1011—first touch electrode; 1012—second touch electrode; 1013—third touch electrode; 1010—sub-touch electrode; 102—center touch electrode; 105—conventional touch electrode; 100—base substrate; 111—wire; 112—touch detection chip; 114—insulating layer; 121—circular region; 122—polygonal ring region; 123—annular sector region; 124—polygonal region; 125—trapezoidal region; 151—via hole; 160—touch panel; 180—display panel; 1801—lower substrate; 1802—upper substrate.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at lease one. The terms “comprises,” “comprising,” “includes,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “on,” “under,” “right,” “left” and the like are only used to indicate relative position relationship, and when the position of the object which is described is changed, the relative position relationship may be changed accordingly.

In general, the shapes of touch panels of intelligent devices are not limited to the usual rectangle, a plurality of shapes such as a circle, an octagon or the like are also adopted, so as to satisfy user's requirements of fashion and beauty. As touch panels of most intelligent wearable devices are in non-rectangular (irregular) shapes, the conventional touch electrode structure applied in a rectangular device is no longer applicable. Many problems may be caused in the case that the conventional touch electrode structure is continuously applied in the irregular touch panels. For instance, touch electrodes at the edges of display regions or at the edges of touch regions are difficult to design. As the edge of an irregular display panel or an irregular touch panel is usually in a cambered and polygonal shape but the general touch electrode patterns are rectangular and cannot well match with it, touch electrodes at edge areas of display regions or touch regions cannot completely cover the edge of the display regions or the touch regions. Due to the incomplete or uneven coverage of the touch electrodes at an edge or a corner of the touch panel or the exceeding of the display regions, the touch accuracy cannot be guaranteed, and hence the defects such as inaccurate reporting or poor linearity are occurred.

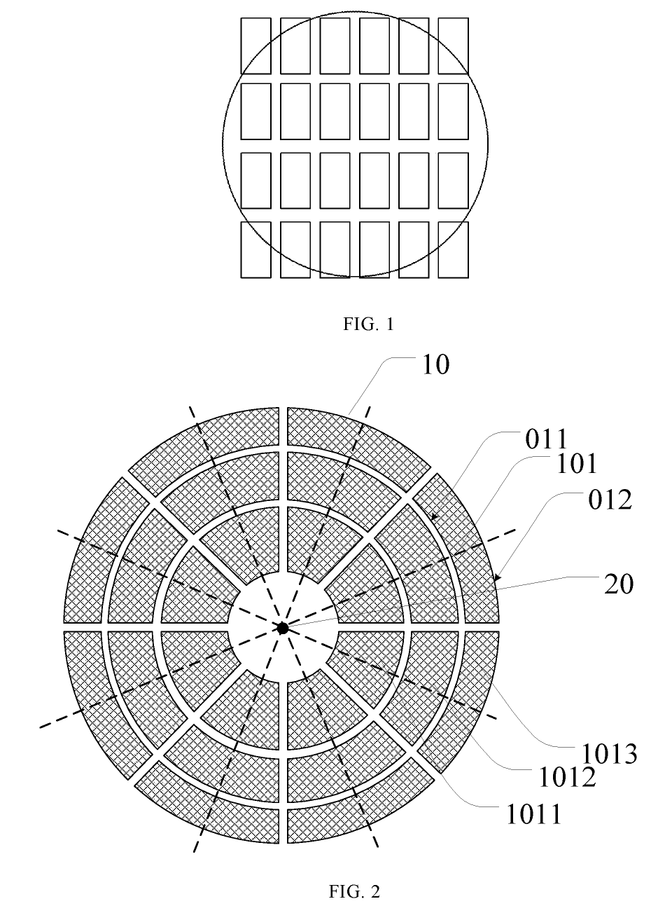

As illustrated in FIG. 1, patterns of touch electrodes in the conventional touch panels mainly adopt rectangular patterns. With the non-rectangular (irregular) displays, such as circular displays, are increasingly widely used, rectangular touch electrode patterns cannot well match with the edge of the touch panel or the edge of the display panel, so that the touch electrodes at edge areas of touch regions or the edge areas of display regions cannot completely cover the edges of the display regions or the edges of the touch regions, or patterns of the touch electrodes will exceed the display regions. Thus, the touch accuracy cannot be guaranteed, and hence the defects such as inaccurate reporting or poor linearity are occurred. For instance, as illustrated in FIG. 1, a rectangular array in FIG. 1 represents patterns of touch electrodes. A circular in FIG. 1 represents an irregular touch panel or a display panel, or an irregular touch region or a display region.

At least one embodiment of the present disclosure provides a touch electrode structure, and the touch electrode structure comprises at least one touch electrode group, the at least one touch electrode group is arranged around a center; each touch electrode group comprises a plurality of touch electrodes, the plurality of touch electrodes in each touch electrode group are arranged in a direction from a position closer to the center to a position further away from the center respectively, and a size of a side portion of each touch electrode away from the center along a circumferential direction is greater than a size of a side portion of the touch electrode close to the center along the circumferential direction.

The touch electrode structure may be applied in a non-rectangular touch panel, which is capable of solving the problems such as inaccurate reporting, poor linearity and the like caused by the incomplete or uneven coverage of the touch electrodes at the edges or corners of the touch panel, the application range of the touch devices is extended, the control difficulty is reduced. Non-rectangle, for instance, comprises the shapes of circle, ring, sector, annular sector, polygon and polygonal ring.

Description will be given below with reference to several embodiments.

### First Embodiment

The present embodiment provides a touch electrode structure, as illustrated in FIG. 2, the touch electrode structure comprises a plurality of touch electrode groups 10, the plurality of touch electrode groups 10 are arranged around a center 20. Each touch electrode group 10 includes a plurality of touch electrodes 101. The plurality of touch electrodes 101 in each touch electrode group 10 are arranged in a direction from a position closer to the center 20 to a position further away from the center 20 respectively, and a size of a side portion 012 of each touch electrode 101 away from the center along a circumferential direction is greater than a size of a side portion 011 of the touch electrode close to the center along the circumferential direction.

FIG. 2 illustrates eight touch electrode groups 10, and each touch electrode group 10 includes three touch electrodes 101. It should be noted that, FIG. 2 is only illustrative and the number of the touch electrode groups and the number of the touch electrodes in each touch electrode group are not limited to cases as illustrated. The number of the touch electrode groups and the number of the touch electrodes in each touch electrode group may be set as required. The following embodiments are the same in this aspect.

For instance, in one example of the present embodiment, as illustrated in FIG. 2, the plurality of touch electrodes in each touch electrode group 10 may be arranged in a line, for instance, arranged linearly. For instance, arranged in ray, the plurality of touch electrodes 101 in each touch electrode group 10 are arranged along a ray in the direction from the position closer to the center to the position further away from the center respectively; and the plurality of touch electrodes 101 in the touch electrode group 10 are arranged by taking the ray as a center line. Dotted lines in FIG. 2 represent rays respectively.

For instance, as illustrated in FIG. 2, the plurality of touch electrode groups are dispersedly arranged around the center 20. For instance, each touch electrode group corresponds to a ray which takes the center 20 as an end point. Thus, the plurality of touch electrode groups correspond to a plurality of rays taking the center 20 as the end point. Each ray extends outwards by taking the center 20 as a starting point. The ray is a straight line provided with an end point, namely the ray may be infinitely extended towards one side. The touch electrode structure provided by the present embodiment is disposed on a base substrate of a touch panel. In the touch structure, the plurality of touch electrodes in each touch electrode group are limited to be extended to the edge of the base substrate of the touch panel. The following embodiments may be the same in this aspect.

For instance, in one example of the present embodiment, an average size of the touch electrodes 101 away from the center along the circumferential direction is greater than an average size of the touch electrodes 101 close to the center along the circumferential direction. As illustrated in FIG. 2, a first touch electrode 1011, a second touch electrode 1022 and a third touch electrode 1012 are sequentially arranged in the direction from being close to the center 20 to being away from the center 20. The average size of the third touch electrode 1013 along the circumferential direction is greater than the average size of the first touch electrode 1011 and greater than the average size of the second touch electrode 1012 along the circumferential direction. The average size of the second touch electrode 1012 along the circumferential direction is greater than the average size of the first touch electrode 1011 along the circumferential direction.

For instance, as illustrated in FIG. 2, each touch electrode group 10 in the shape of ray; the plurality of touch electrode groups 10 are sequentially arranged around the center 20 and almost cover a circular region or an annular sector region.

It should be noted that, the circumferential direction described in each embodiment of the present disclosure, for instance, refers to the circumferential direction of a circle or a sector taking the center 20 encircled by the plurality of touch electrode groups as the center of a circle; or the circumferential direction of a polygon or a polygonal ring taking the center 20 encircled by the plurality of touch electrode groups as the center. For instance, the circumferential direction of the polygon or the polygonal ring may be the direction of inner perimeter or outer perimeter. The center, for instance, refers to the center of a circle, a symmetric center, a center of gravity, a vertex, etc., for instance, refers to the center of a circle, a symmetric center, a center of gravity, a vertex, etc. of a region completely covered by the touch electrodes provided by the embodiments of the present disclosure. The “average size” described in the embodiments of the present disclosure, for instance, refers to the average value of the side length of the side portion 012 away from the center and the side length of the side portion 011 close to the center, or refers to the average value of the side length of the side portion 012 away from the center in the circumferential direction and the side length of the side portion 011 close to the center in the circumferential direction.

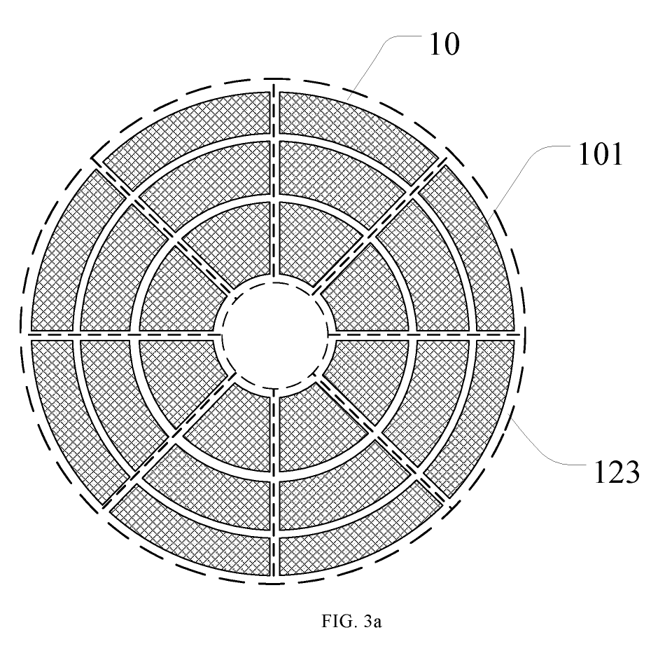

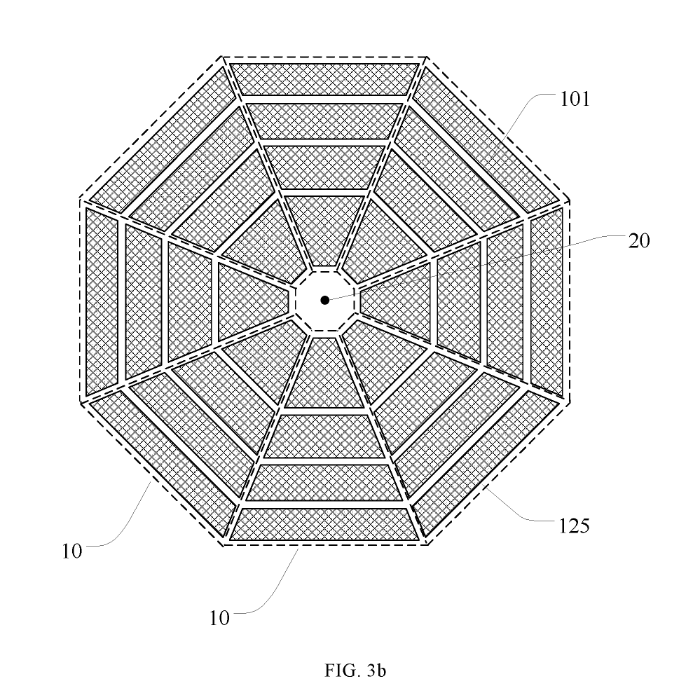

For instance, as illustrated in FIG. 3a, in one example of the present embodiment, each touch electrode group 10 may be disposed in an annular sector region 123, and the plurality of touch electrodes 101 in each touch electrode group almost cover the entire annular sector region 123.

For instance, as illustrated in FIG. 3b, in one example of the present embodiment, each touch electrode group 10 is disposed in a trapezoidal region 125, and the plurality of touch electrodes 101 in each touch electrode group 10 almost cover the entire trapezoidal region 125.

It should be noted that, a region provided with each touch electrode group represented by the dotted line in FIGS. 3a and 3b, for instance, refers to a region formed by the mutual connection of the peripheries of the plurality of touch electrodes in each touch electrode group, or an annular sector region or a trapezoidal region with minimum area provided with patterns obtained after the mutual connection of the peripheries of the plurality of touch electrodes. “Almost cover(ing)” in the description that the plurality of touch electrodes 101 almost cover the annular sector region 123 and the plurality of touch electrodes 101 almost cover the trapezoidal region 125, for instance, indicates that the area of the plurality of touch electrodes in each touch electrode group accounts for more than 70% of the area of the region provided with each touch electrode group. Moreover, for instance, the area of the plurality of touch electrodes in each touch electrode group accounts for more than 80% of the area of the region provided with each touch electrode group. Furthermore, for instance, the area of the plurality of touch electrodes in each touch electrode group accounts for more than 90% of the area of the region provided with each touch electrode group.

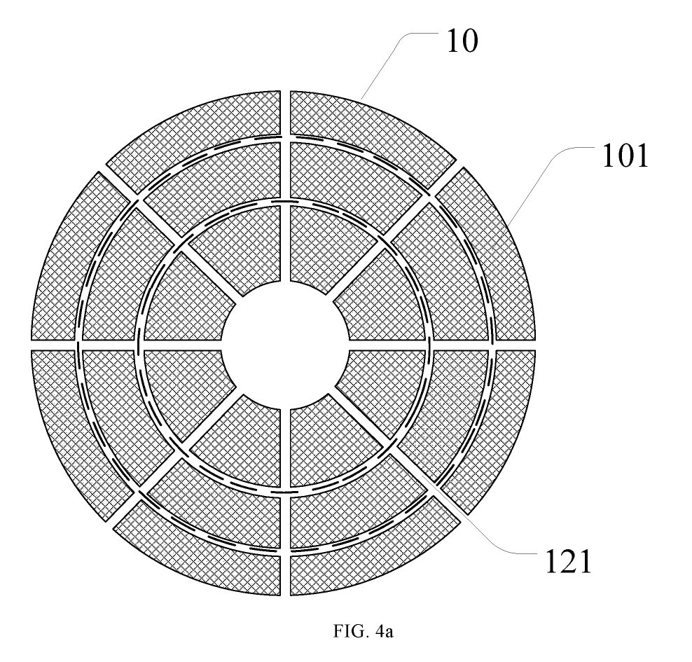

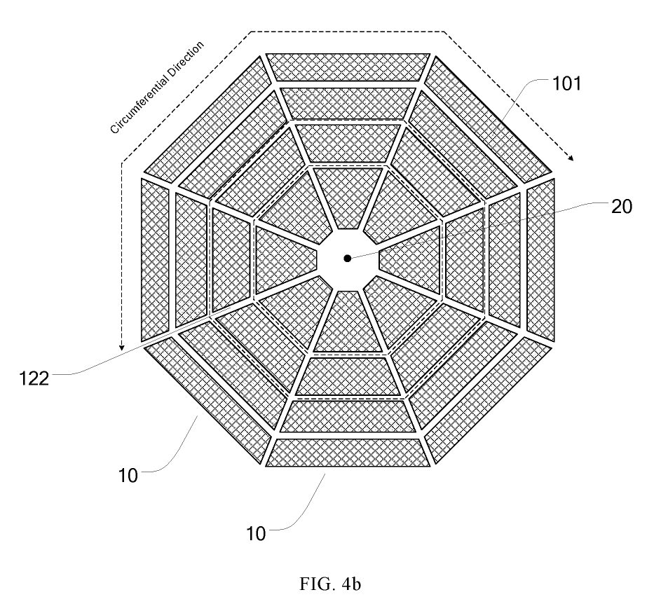

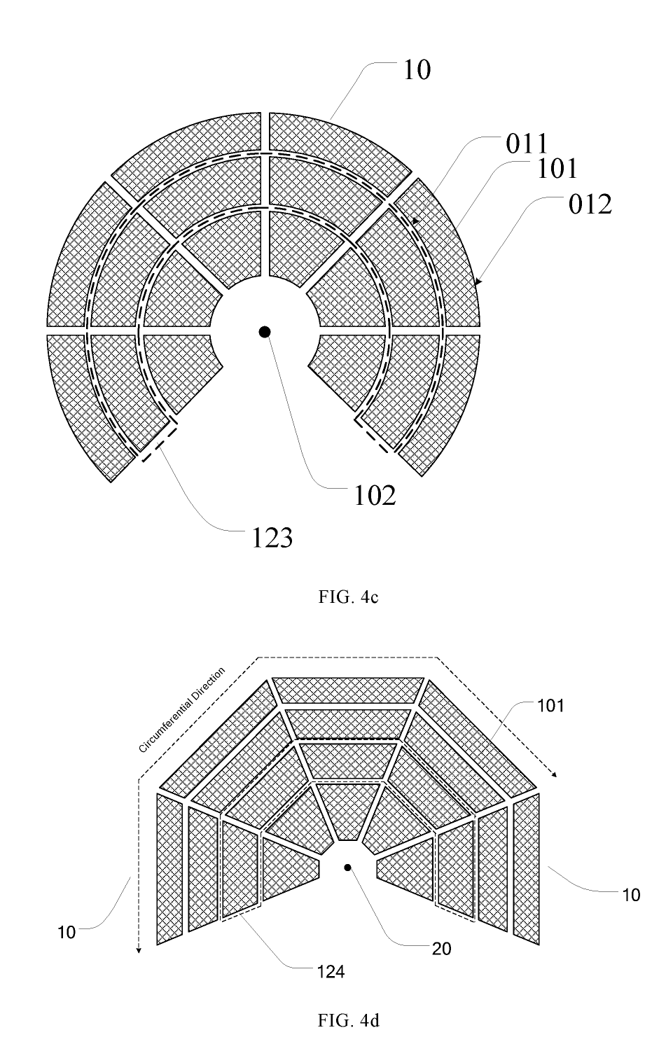

For instance, in one example of the present embodiment, as illustrated in FIG. 4a, the number of the touch electrode groups 10 is plural, and the circumferentially adjacent touch electrodes 101 in the plurality of touch electrode groups 10 are disposed in a ring region 121.

For instance, in one example of the present embodiment, as illustrated in FIG. 4b, each touch electrode group 10 is disposed in a trapezoidal region, and a plurality of circumferentially adjacent touch electrodes are disposed in a polygonal ring region 122.

For instance, in one example of the embodiment, as illustrated in FIG. 4c, each touch electrode group 10 is disposed in an annular sector region, and a plurality of circumferentially adjacent touch electrodes are disposed in an annular sector region 123.

For instance, in one example of the embodiment, as illustrated in FIG. 4d, each touch electrode group 10 is disposed in a trapezoidal region, and a plurality of circumferentially adjacent touch electrodes are disposed in a polygonal region 124.

It should be noted that, FIG. 4a illustrates the case that the plurality of touch electrode groups 10 almost cover a circular region or a ring region. The plurality of touch electrode groups 10 may also almost fully cover the other non-rectangular regions. For instance, as illustrated in FIG. 4b, the plurality of touch electrode groups 10 almost cover a polygonal region or a polygonal ring region, and description is given in the figure by taking a regular octagon or a regular octagonal ring for example. As illustrated in FIG. 4c, the plurality of touch electrode groups 10 almost cover an entire sector region or an entire annular sector region. As illustrated in FIG. 4d, the plurality of touch electrode groups 10 almost cover an entire polygonal region. As illustrated in FIGS. 4a to 4d, the plurality of touch electrodes which are the closest to the center 20 may be close to the center 20 as much as possible, or close to the center 20 to cover a circular region, a polygonal region or a sector region on the premise of satisfying the touch accuracy. In the case that the plurality of touch electrode groups 10 almost cover an entire ring region, an entire polygonal ring region or an entire annular sector region, a plurality of touch electrodes which are the closest to the center 20 may be close to an inner ring of the ring region, the polygonal ring region or the annular sector region as much as possible. Of course, in the embodiments of the present disclosure, the touch electrodes 101 are insulated from each other.

For instance, in one example of the embodiment, as illustrated in FIG. 2, in order to satisfy the requirement of constant resistance, in the plurality of touch electrodes 101 of each touch electrode group 10, the radial sizes of the touch electrodes arranged in the direction from being close to the center 20 to being away from the center 20 are sequentially reduced. In this way, the area of each touch electrode is equal or roughly equal, so that the touch electrodes with constant resistance are obtained. The radial direction, for instance, refers to the direction of each ray taking the center 20 encircled by the touch electrode groups as an end point. Or, the radial direction, for instance, refers to the diametric or radial direction of a circle taking the center 20 encircled by the touch electrode groups as the center of a circle.

For instance, the shapes of the plurality of touch electrodes 101 may be non-rectangular quadrangles, for example, as illustrated in FIGS. 4a to 4d, the non-rectangular quadrangle includes an annular sector or a trapezoid.

For instance, as illustrated in FIG. 2, in each touch electrode group 10, the shape of each touch electrode 101 is an annular sector. The circumferential length of each annular sector is larger and larger being away from the center 20 or the center 20 of a circle, and the width (radial size) is smaller and smaller being away from the center 20 or the center 20 of a circle. For instance, the width of an annular sector at the furthest end (touch electrodes which are the farthest from the center 20 or the center 20 of a circle) is not less than 2 mm; the distance between two adjacent touch electrodes 101, for instance, may be greater than 6 μm; and the circumferential length of the annular sector at the furthest end, for instance, may be not greater than 6 mm.

The size of the touch electrodes in each embodiment of the present disclosure must satisfy the requirement of touch accuracy. For instance, the density of the touch panel is usually in millimeter scale. Therefore, the density and the area of each self-capacitive electrode may be selected according to the required touch density, so as to ensure the required touch accuracy. For instance, the area of each touch electrode is greater than or equal to 4 mm² and less than or equal to 36 mm². As the density of a display panel is usually in micrometer scale, in general, a self-capacitive electrode corresponds to a plurality of sub-pixels in the display panel.

For instance, in the present embodiment, the material of the plurality of touch electrodes in each touch electrode group is transparent conductive material, e.g., transparent metal oxide such as indium tin oxide (ITO) and indium zinc oxide (IZO), which is not limited thereto. The following embodiments may be the same in this aspect.

For instance, the plurality of touch electrodes in each touch electrode group of the touch electrode structure provided by the present embodiment is formed by patterning process, which is not limited thereto. The following embodiments may be the same in this aspect.

It should be understood that, in the embodiment of the present disclosure, the patterning process may only includes photolithographic process, or includes photolithographic process and etching process, or includes printing, ink jet and other processes for forming specific patterns. The photolithographic process refers to a process of forming patterns via photoresist, a mask, an exposure machine and the like by the technical processes such as film forming, exposing and developing. Corresponding patterning processes may be selected according to the structure formed in the present embodiment of the present disclosure.

The touch electrode structure provided by the embodiment may be disposed in a non-rectangular region, and hence the touch electrode structure may be applied in a non-rectangular touch panel. The non-rectangular region, for instance, includes a sector region, an annular sector region, a circular region, a ring region, a polygonal region and a polygonal ring region. In addition, the touch electrode structure may effectively and completely cover the non-rectangular (irregular) touch panel as required, and hence the defects such as inaccurate reporting and poor linearity due to incomplete coverage of touch electrodes at edges or corners of the touch panel are avoided.

### Second Embodiment

On the basis of the first embodiment, the touch electrode structure further comprises a center touch electrode 102. The center touch electrode 102 may be disposed at the center 20.

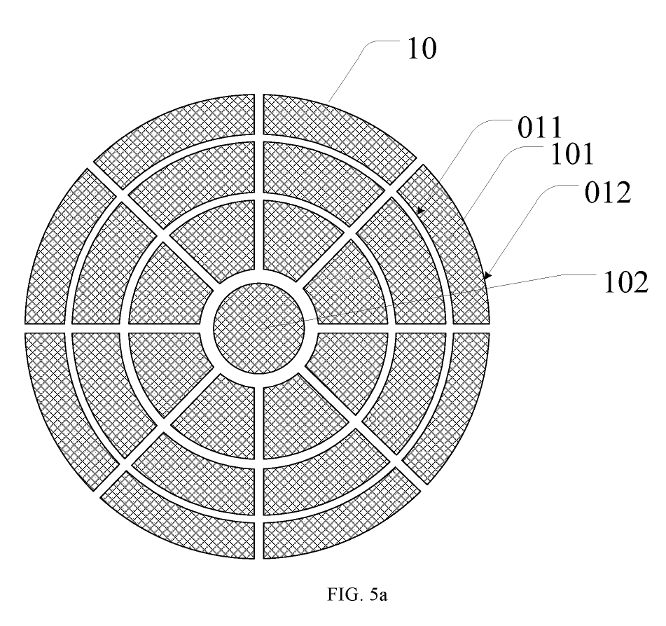

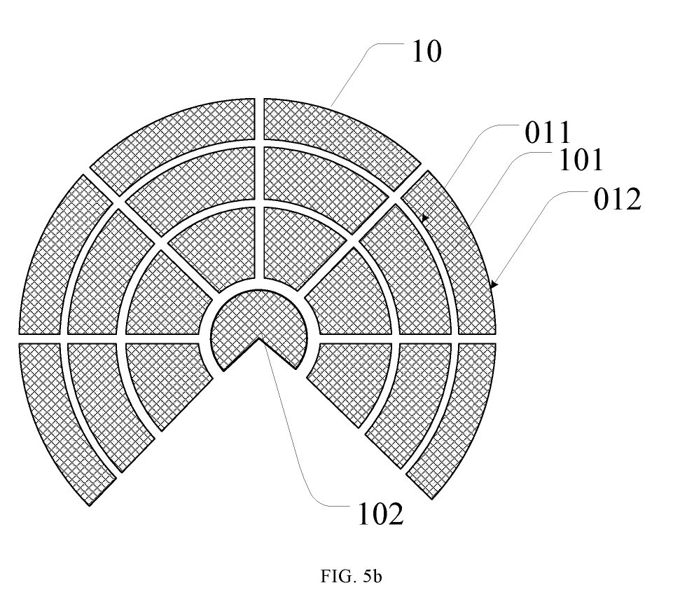

As illustrated in FIG. 5a, in one example of the present embodiment, the center touch electrode 102 and each touch electrode 101 in a plurality of touch electrode groups 10 cover an entire circular region.

As illustrated in FIG. 5b, in one example of the present embodiment, the center touch electrode 102 and each touch electrode 101 in the plurality of touch electrode groups 10 covers an entire sector region.

For instance, the center touch electrode 102 and each touch electrode 101 in the plurality of touch electrode groups 10 cover an entire polygonal region.

It should be noted that, the regions completely covered by the center touch electrode 102 and each touch electrode 101 in the plurality of touch electrode groups 10 are not limited to the above examples, and may be determined according to the number of the touch electrode groups 10, the shape of each touch electrode in the touch electrode groups and the shape of the center touch electrode 102, etc.

The arrangement of the center touch electrode can increase the touch accuracy at the center of the touch panel.

For instance, in the present embodiment, the material of the center touch electrode may be transparent conductive material, e.g., transparent metal oxide such as indium tin oxide (ITO) and indium zinc oxide (IZO), which is not limited thereto. The following embodiments may be the same in this aspect.

For instance, in the touch electrode structure provided by the present embodiment, the center touch electrode and the plurality of touch electrodes in each touch electrode group are formed by a same patterning process, which is not limited thereto. The following embodiments may be the same in this aspect.

### Third Embodiment

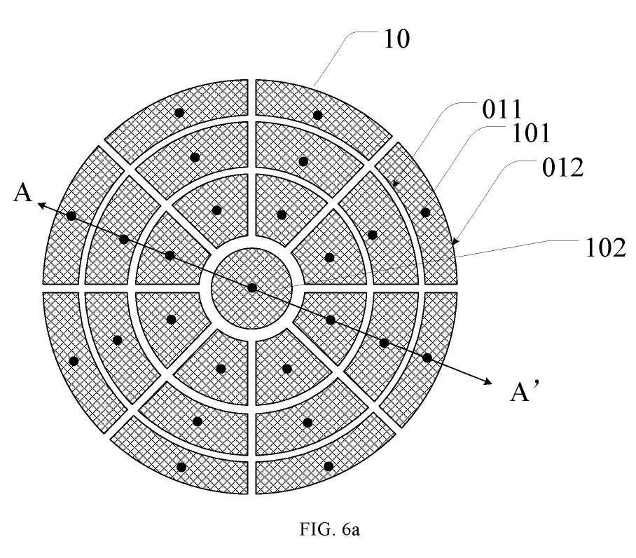

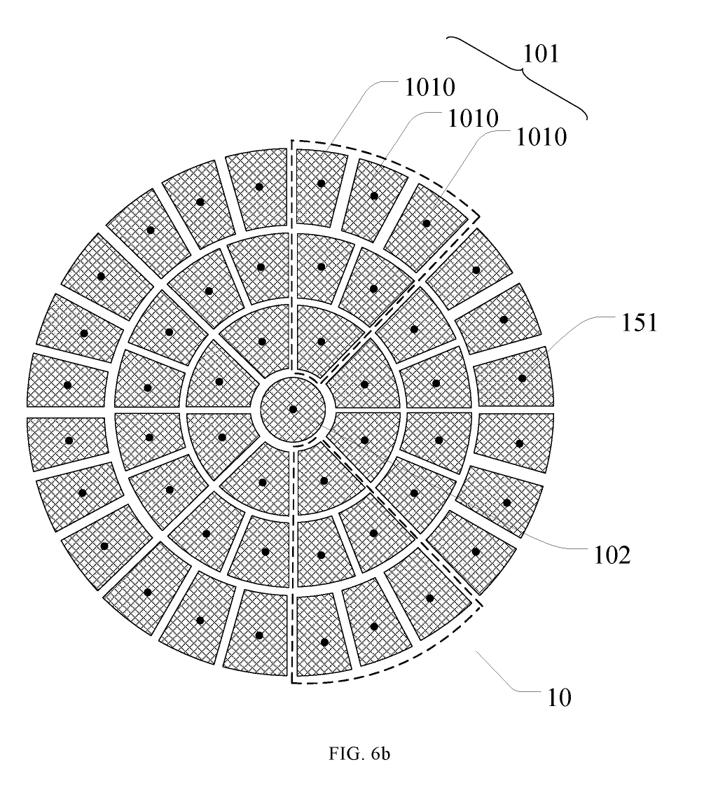

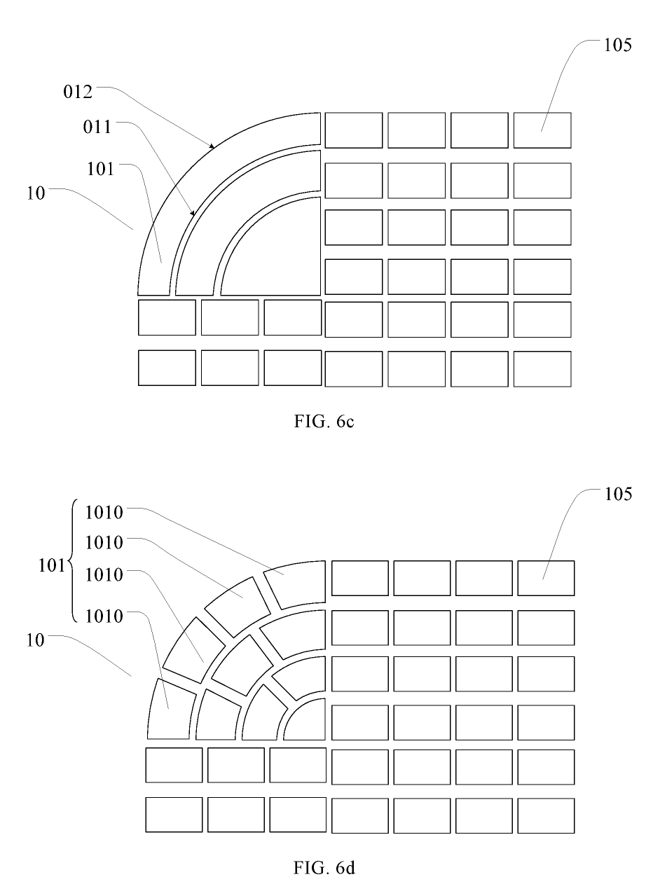

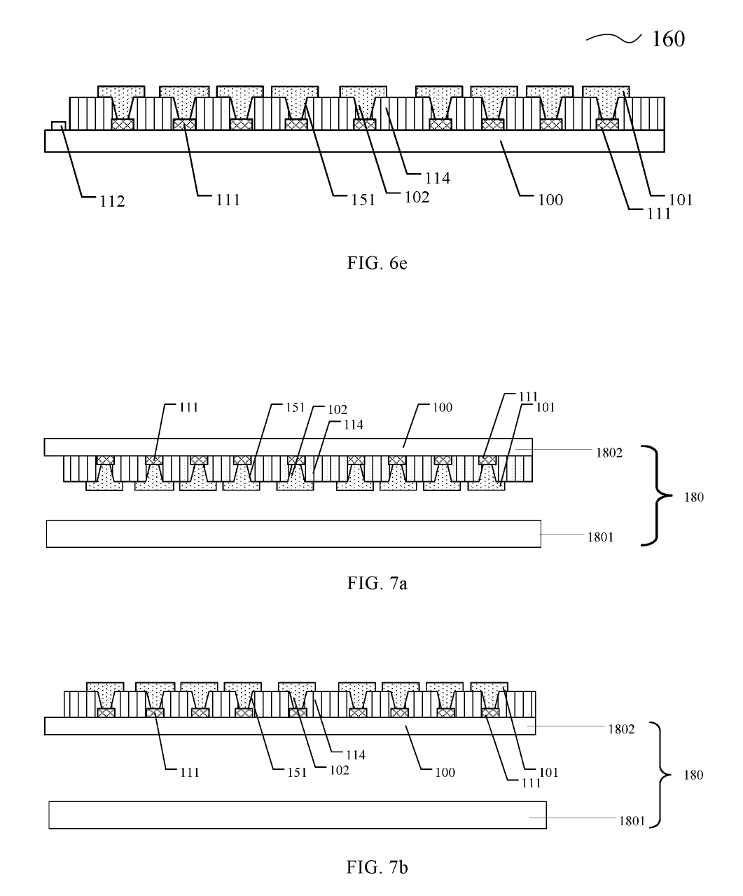

In the touch electrode structure provided by any one of the above embodiments, for instance, as illustrated in FIGS. 6a, 6b and 6e, the touch electrode structure further comprises a plurality of wires 111 (as illustrated in FIG. 6e). Each touch electrode 101 may be connected with each wire 111 through a via hole 151. Each touch electrode 101 in each touch electrode group 10 is respectively electrically connected with each wire 111 to input or output signals. FIGS. 6a and 6b are plan views of the touch electrode structure, and FIG. 6e is an A-A′ sectional view of FIG. 6a. It should be noted that, each touch electrode 101 may also be arranged in the same layer and directly connected with each wire 111, which is not limited herein.

For instance, as illustrated in FIG. 6e, a plurality of wires 111 are disposed on a base substrate 100; and an insulating layer 114 is disposed on a layer provided with the plurality of wires 111, and the insulating layer 114 is provided with a plurality of via holes 151. For instance, the via holes 151 are through holes passed through the insulating layer 114. The center touch electrode 102 and each touch electrode 101 in each touch electrode group 10 are disposed on the insulating layer 114. And the center touch electrode 102 and each touch electrode 101 in each touch electrode group 10 are electrically connected with the wires through the via holes 151 respectively. For instance, the center touch electrode 102 and the touch electrodes 101 in the touch electrode groups 10 are connected with different wires respectively. In the case that the center touch electrode is not arranged, the wire connected with the center touch electrode is also not arranged. For instance, the structure as illustrated in FIG. 6e may form a touch panel 160.

For instance, in order to satisfy the requirement of constant resistance, in the plurality of touch electrodes 101 of the touch electrode groups 10, besides the means that the radial sizes of the touch electrodes arranged in the direction from being close to the center 20 to being away from the center 20 are sequentially reduced adopted, and the means as illustrated in FIG. 6b may also be adopted, in which at least one touch electrode in the touch electrode group 10 may be divided into a plurality of sub-touch electrodes 1010 arranged in the circumferential direction, namely the at least one touch electrode 101 in the touch electrode group 10 includes a plurality of sub-touch electrodes 1010 arranged in the circumferential direction. As illustrated in FIG. 6b, in each touch electrode group 10, the touch electrode which is the closest to the center 20 is not divided, and the outermost touch electrode 101 is divided into three circumferentially arranged sub-touch electrodes 1010. The touch electrode disposed between the touch electrode 101 which is the closest to the center and the outermost touch electrode 101 is divided into two circumferentially arranged sub-touch electrodes 1010. The sub-touch electrodes 1010 are insulated from each other. The sub-touch electrodes may be electrically connected with different wires 111 respectively.

For instance, as illustrated in FIG. 6b, in order to satisfy the requirement of constant resistance, the area of each sub-touch electrode 1010 is equal or roughly equal; the area of touch electrode is equal or roughly equal; and the area of each sub-touch electrode 1010 and the area of each touch electrode 101 are equal or roughly equal. That is to say, the area of each sub-touch electrode 1010 is equal to the area of the other touch electrode 101 which is not divided. The size of each sub-touch electrode, for instance, may refer to the size of the above-mentioned touch electrode, which is not limited thereto.

For instance, the shape of the plurality of sub-touch electrodes includes a polygon, for example, a sector, a trapezoid and a rectangle, etc.

For instance, as illustrated in FIG. 6c, in one example of the present embodiment, the touch electrode structure comprises a touch electrode group 10. The touch electrode group is arranged around a center 20. The touch electrode group 10 includes a plurality of touch electrodes 101. The plurality of touch electrodes 101 in the touch electrode group 10 are all arranged around the center 20. The plurality of touch electrodes 101 in the touch electrode group 10 are arranged in the direction from the position closer to the center to the position further away from the center respectively, and the size of a side portion 012 of each touch electrode 101 away from the center along the circumferential direction is greater than the size of a side portion 011 of the touch electrode close to the center along the circumferential direction.

For instance, as illustrated in FIG. 6c, the touch electrodes in the touch electrode group 10 are arranged in a shape of ray, for example, the touch electrodes in the touch electrode group 10 are arranged in a shape of ray by taking the center 20 as an end point.

For instance, as illustrated in FIG. 6d, at least one touch electrode 101 in the touch electrode group 10 is divided into a plurality of circumferentially arranged sub-touch electrodes 1010. That is to say, the at least one touch electrode 101 in the touch electrode group 10 includes a plurality of circumferentially arranged sub-touch electrodes 1010.

For instance, as illustrated in FIGS. 6c and 6d, in addition to the touch electrode structure provided by the present embodiment of the present disclosure, other types of touch electrode structures may also be provided. For instance, touch electrodes with rectangular patterns 105 may also be provided.

The touch electrode structure provided by the embodiment of the present disclosure may cover the entire non-rectangular touch panel or cover a non-rectangular touch region of the non-rectangular touch panel (the non-rectangular touch panel comprises a non-rectangular touch region, besides that, the non-rectangular touch panel further comprises one or more rectangular regions. For instance, the touch electrodes in a shape of conventional rectangular may also be disposed in the rectangular regions).

The touch electrode structure provided by at least one embodiment of the present disclosure not only may be applied in the conventional flat touch panel but also may be applied in curved touch panels and even spherical touch panels due to the unique arrangement mode of touch electrodes, and a good touch effect is achieved.

### Fourth Embodiment

The present embodiment provides a touch panel, which comprises any one of the touch electrode structure provided by the first embodiment, the second embodiment and the third embodiment. For instance, the touch panel may comprise any one of one glass solution (OGS) touch panel, in-cell touch panel and on-cell touch panel. The structure of the OGS touch panel provided by the present embodiment, for instance, may be as illustrated in FIG. 6e. The touch panel as illustrated in FIG. 6e may refer to the above-mentioned description.

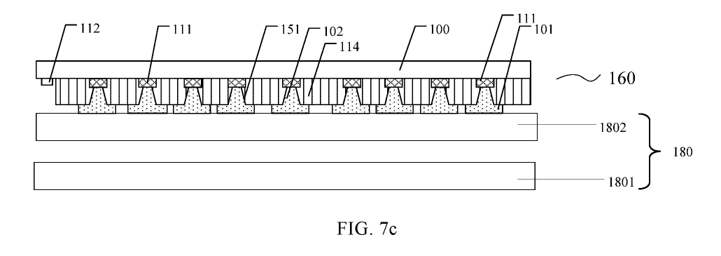

For instance, in the in-cell touch panel, the touch electrode 101 in each touch electrode group 10 or the center touch electrode 102 and the touch electrode 101 in each touch electrode group 10 may be disposed on a surface of an upper substrate of a display panel facing a lower substrate or a surface of the lower substrate facing the upper substrate. As illustrated in FIG. 7a, the center touch electrode 102 and the touch electrode 101 in each touch electrode group 10 are disposed on a surface of an upper substrate 1802 of a display panel 180 facing a lower substrate 1801.

For instance, in the on-cell touch panel, the touch electrode 101 in each touch electrode group 10 or the center touch electrode 102 and the touch electrode 101 in each touch electrode group 10 may be disposed on one side of an upper substrate away from a lower substrate. As illustrated in FIG. 7b, the center touch electrode 102 and the touch electrode 101 in each touch electrode group 10 are disposed on one side of the upper substrate away from the lower substrate.

The display panel 180 includes the lower substrate 1801 and the upper substrate 1802 which are cell-assembled. For instance, a pixel array structure is also disposed on the lower substrate 1801, and a color filter layer, a black matrix and the like may also be disposed on the upper substrate 1802, which are not limited thereto. For instance, in the display panel, the touch electrodes may be independently arranged and may also be multiplexed as common electrodes in the display panel, which are not limited herein.

For instance, as illustrated in FIGS. 6e and 7c, the touch panel further comprises a touch detection chip 112. In the touch panel provided by the present embodiment, each of the wires iii is connected to the touch detection chip 112. When a self-capacitive touch panel is touched by a finger, the capacitance of the finger will be overlapped to the corresponding touch electrode, and the touch detection chip may determine a touch position by detecting the capacitance variation of the touch electrodes in the touch period.

### Fifth Embodiment

The present embodiment provides a display device, which comprises any one of the touch electrode structure provided by the first embodiment, the second embodiment and the third embodiment.

For instance, the display device further comprises a display panel, and the touch electrode structure is disposed on the display panel. The display device with the structure, for instance, is an in-cell touch display panel or an on-cell touch display panel. The touch electrode structure in the in-cell touch display panel or the on-cell touch display panel, for instance, may refer to the fourth embodiment, and detailed descriptions will be omitted here.

For instance, as illustrated in FIG. 7c, the display device further comprises a display panel 180 and a touch panel 160 disposed on a display side of the display panel, and the touch electrode structure is disposed on the touch panel. The display device with the structure, for instance, is an OGS touch display panel.

For instance, the display device comprises a liquid crystal display device or an organic light-emitting diode display device.

For instance, the display device may be a display apparatus such as a liquid crystal display panel, an electronic paper and an OLED (organic light-emitting diode), and a mobile phone, a television, a digital picture frame, a mobile phone, a watch, a tablet computer, a notebook computer, a navigation system and any other product or component including the above-mentioned display apparatus having a display function.

It should be noted that, in order to clearly illustrated, not all the structures of the touch panel, the display panel or the display device are provided. In order to achieve necessary functions of the touch panel, the display panel or the display device, other structures not shown may be set by those skilled in the art according to specific application conditions, which are not limited in the present disclosure. The technical effects of the touch panel, the display panel or the display device provided by the embodiment refer to the technical effects of the touch electrode structure provided by the above-mentioned embodiments, and detailed descriptions will be omitted here.

Embodiments of the present disclosure provide a touch electrode structure and a touch panel and a display device comprising the touch electrode structure. The touch electrode structure comprises at least one touch electrode group, and at least one touch electrode group is arranged around a center; each touch electrode group comprises a plurality of touch electrodes, the plurality of touch electrodes in each touch electrode group are arranged in a direction from a position closer to the center to a position further away from the center respectively; and a size of a side portion of each touch electrode away from the center along a circumferential direction is greater than a size of a side portion of the touch electrode close to the center along a circumferential direction. The touch electrode structure and the touch panel and the display device comprising the touch electrode structure can have at least one of the following advantages:

(1) The touch electrode structure provided by the embodiment of the present disclosure may be applied in a non-rectangular touch panel, according to the requirements, the touch electrode structure can effectively and completely cover the non-rectangular (irregular) touch panel, and the defects of inaccurate reporting, poor linearity and the like caused by the incomplete coverage of touch electrodes at edges or corners of the touch panel are avoided. The touch electrode structure provided by the embodiments of the present disclosure may cover the entire non-rectangular touch panel or cover the non-rectangular touch region of the non-rectangular touch panel (the non-rectangular touch panel includes a non-rectangular touch region, and further includes one or more rectangular regions, for instance, the conventional rectangular touch electrodes may be disposed in the rectangular regions).

(2) In the touch electrode structure provided by at least one embodiment of the present disclosure, by proper setting of the positions and the number of the touch electrodes, the touch panel adopting the touch electrode structure provided by the present embodiment can achieve a high touch uniformity.

(3) The touch electrode structure provided by at least one embodiment may further comprise the center touch electrode. The arrangement of the center touch electrode can increase the touch accuracy at the center of the touch panel.

(4) The touch electrode structure provided by at least one embodiment not only may be applied in the conventional flat touch panel but also may be applied in curved touch panels and even spherical touch panels due to the unique arrangement mode of touch electrodes, and a good touch effect can be achieved.

(5) The touch electrode structure provided by at least one embodiment may be combined with the conventional touch electrode structures to form touch electrode structures of various nonrectangular (irregular) touch panels, not only achieves good touch performances but also has the characteristics of fashion and beauty, and hence can meet various needs of users.

The following points need to be explained:

(1) The drawings of the embodiments of the present disclosure only relate to the structures which relate to the embodiments of the present disclosure, and other structures may refer to the common design.

(2) For the sake of clarity, in the drawings used for describing the embodiments of the present disclosure, the thickness of the layer or the area is enlarged or reduced, that is, the drawings are not drawn in the actual proportion. It can be understood that, in the case that, an element such as a layer, a membrane, a region or a substrate and the like is called located “on” or “below” another element, the element can be “directly” located “on” or “below” another element, or there may be an intermediate element.

(3) In the absence of conflict, the different embodiments of the present disclosure and the features of the same embodiment can be combined to obtain a new embodiment.

What are described above is related to the illustrative embodiments of the disclosure only and not limitative to the scope of the disclosure, the scopes of the disclosure are defined by the accompanying claims.

The present application claims priority of the Chinese Patent Application No. 201510587830.3 filed on Sep. 15, 2015, the disclosure of which are incorporated herein by its reference in its entirety as part of the present application.

1. A touch electrode structure, comprising at least one touch electrode group,
wherein the at least one touch electrode group is arranged around a center; each touch electrode group comprises a plurality of touch electrodes, the plurality of touch electrodes in each touch electrode group are arranged in a direction from a position closer to the center to a position further away from the center respectively; and a size of a side portion of each touch electrode away from the center along a circumferential direction is greater than a size of a side portion of the touch electrode close to the center along the circumferential direction.

2. The touch electrode structure according to claim 1, wherein the plurality of touch electrodes in each touch electrode group are arranged along a ray in the direction from the position closer to the center to the position further away from the center respectively; and the plurality of touch electrodes in each touch electrode group are arranged by taking the ray as a center line.

3. The touch electrode structure according to claim 1, wherein in the plurality of touch electrodes of each touch electrode group, an average size of the touch electrodes further away from the center along the circumferential direction is greater than an average size of the touch electrodes closer to the center along the circumferential direction.

4. The touch electrode structure according to claim 1, wherein a shape of the plurality of touch electrodes as a whole comprises an annular sector or a trapezoid.

5. The touch electrode structure according to claim 1, wherein the touch electrode structure comprises a plurality of touch electrode groups; and circumferentially adjacent touch electrodes in the plurality of touch electrode groups are disposed in an annular sector region, a ring region, a polygonal region or a polygonal ring region.

6. The touch electrode structure according to claim 1, wherein each touch electrode group is disposed in an annular sector region or a trapezoidal region; and the plurality of touch electrodes in each touch electrode group almost cover the annular sector region or the trapezoidal region.

7. The touch electrode structure according to claim 6, wherein each touch electrode group is disposed in an annular sector region, and circumferentially adjacent touch electrodes are disposed in an annular sector region or a ring region; or each touch electrode group is disposed in a trapezoidal region, and the circumferentially adjacent touch electrodes are disposed in a polygonal region or a polygonal ring region.

8. The touch electrode structure according to claim 1, wherein radial sizes of the touch electrodes arranged in the direction from the position closer to the center to the position further away from the center are sequentially reduced.

9. The touch electrode structure according to claim 1, wherein an area of each touch electrode is equal or roughly equal.

10. The touch electrode structure according to claim 1, wherein at least one touch electrode in each touch electrode group comprises a plurality of circumferentially arranged sub-touch electrodes.

11. The touch electrode structure according to claim 10, wherein an area of each sub-touch electrode and an area of each touch electrode are equal or roughly equal.

12. The touch electrode structure according to claim 10, wherein a shape of the plurality of sub-touch electrodes as a whole comprises a polygon.

13. The touch electrode structure according to claim 1, further comprising a center touch electrode, wherein the center touch electrode is disposed at the center.

14. The touch electrode structure according to claim 1, wherein the touch electrode structure is disposed in a non-rectangular region.

15. The touch electrode structure according to claim 14, wherein the non-rectangular region comprises a sector region, an annular sector region, a circular region, a ring region, a polygonal region and a polygonal ring region.

16. A touch panel, comprising the touch electrode structure according to claim 1.

17. A display device, comprising the touch electrode structure according to claim 1.

18. The display device according to claim 17, further comprising a display panel, wherein the touch electrode structure is disposed on the display panel.

19. The display device according to claim 17, further comprising a display panel and a touch panel disposed on a display side of the display panel, wherein the touch electrode structure is disposed on the touch panel.

20. The display device according to claim 1, wherein the display device comprises a liquid crystal display device or an organic light-emitting diode display device.
